(19) United States
(12) Patent Application Publication
(10) Pub. No.: US 2010/0330952 A1
(43) Pub. Date: Dec. 30, 2010

(54) PERSONAL SAFETY DEVICE, SYSTEM AND PROCESS

(76) Inventor: Patrick John Yeoman, Ballarat (AU)

Correspondence Address: MORRISON & FOERSTER LLP, 755 PAGE MILL RD, PALO ALTO, CA, 94304-1018, US

(21) Appl. No.: 12/824,045

(22) Filed: Jun. 25, 2010

(30) Foreign Application Priority Data
Jun. 25, 2009 (AU) 2009100650

(51) Int. Cl. H04M 11/04

(52) U.S. Cl. 455/404.2

(57) ABSTRACT

A personal safety system, including: a mobile telephone device; and a personal safety device, including: a sensor, a transceiver module configured to send, in response to activation of the sensor by a user, an activation signal to the mobile telephone device via a wireless link, and an indicator configured to indicate to the user: a device state of the personal safety device, including an activated state corresponding to the activation of the sensor; and reception of an incoming call or message by the mobile telephone device, wherein: the mobile telephone device is configured to generate an alert signal based on the activation signal, and to send the alert signal to a recipient based on alerting configuration data representing the recipient pre-selected by the user; the alert signal represents user location data representing a location of the mobile telephone device; and the sensor includes a proximity sensor which is activated by the personal safety device being out of communication range of the mobile telephone device.

### CROSS-REFERENCE TO RELATED APPLICATIONS

This application claims the benefit of an earlier filed Australian Patent Application Serial Number 2009100650, entitled A PERSONAL SAFETY DEVICE, SYSTEM AND PROCESS, filed Jun. 25, 2009 which is hereby incorporated by reference in its entirety and for all purposes.

### FIELD OF THE INVENTION

The present invention relates to personal safety devices, systems and processes, for example personal safety devices (PSDs) configured to be activated by a user.

### BACKGROUND OF THE INVENTION

In many situations, a person may wish to use their telephone to call someone else for help, but may be unable to do so. For example, if someone has a mobile telephone, they will be able to use their telephone in many areas, but they will still need to operate the telephone to make a call. In particular, it is not always possible or easy for a person in an emergency to remember telephone numbers, to operate a telephone keypad, or even to reach their telephone. For example, if someone is attacked, their telephone may be taken away from them or dropped, or if someone injures themselves, they may be too weak or in pain to access and operate their telephone. On occasion, the person may have inadvertently left their telephone somewhere—such as in a house, car, or office—and therefore may be unable to make a call for help.

It is desired to address or at least alleviate one or more difficulties or limitations of the prior art, e.g., as described above, or at least provide a useful alternative.

### BRIEF SUMMARY OF THE INVENTION

In accordance with the present invention, there is provided a personal safety system, including: a mobile telephone device; and a personal safety device, including: a sensor, a transceiver module configured to send, in response to activation of the sensor by a user, an activation signal to the mobile telephone device via a wireless link, and an indicator configured to indicate to the user: a device state of the personal safety device, including an activated state corresponding to the activation of the sensor; and reception of an incoming call or message by the mobile telephone device, wherein: the mobile telephone device is configured to generate an alert signal based on the activation signal, and to send the alert signal to a recipient based on alerting configuration data representing the recipient pre-selected by the user; the alert signal represents user location data representing a location of the mobile telephone device; and the sensor includes a proximity sensor which is activated by the personal safety device being out of communication range of the mobile telephone device.

The present invention also provides a personal safety process including: detecting an activation of a sensor of a personal safety device by a user; sending, in response to detecting the activation, an activation signal to a mobile telephone device via a wireless link; indicating to the user a device state of the personal safety device, including an activated state corresponding to the activation of the sensor; indicating, by the personal safety device, to the user reception of an incoming call or message by the mobile telephone; generating an alert signal based on the activation signal by the mobile telephone device; and sending the alert signal by the mobile telephone device to a recipient, based on alerting configuration data representing the recipient pre-selected by the user, wherein: the alert signal represents user location data representing a location of the mobile telephone device; and the sensor includes a proximity sensor which is activated by the personal safety device being out of communication range of the mobile telephone device.

The present invention also provides a personal safety system, including: a mobile telephone device; and a personal safety device, including: a sensor, and a transceiver module configured to send, in response to activation of the sensor by a user, an activation signal to the mobile telephone device via a wireless link, wherein: the mobile telephone device is configured to generate an alert signal based on the activation signal, and to send the alert signal to a recipient based on alerting configuration data representing the recipient pre-selected by the user; the alert signal represents user location data representing a location of the mobile telephone device; and the sensor includes a proximity sensor which is activated by the personal safety device being out of communication range of the wireless link.

The present invention also provides a personal safety process including: detecting an activation of a sensor of a personal safety device by a user; sending, in response to detecting the activation, an activation signal to a mobile telephone device via a wireless link; generating an alert signal based on the activation signal by the mobile telephone device; and sending the alert signal by the mobile telephone device to a recipient, based on alerting configuration data representing the recipient pre-selected by the user, wherein: the alert signal represents user location data representing a location of the mobile telephone device; and the sensor includes a proximity sensor which is activated by the personal safety device being out of communication range of the wireless link.

The personal safety device can include a wireless transceiver in the form of a Bluetooth (BT) wireless transceiver, and the link can be a wireless link using a protocol such as the Bluetooth (BT) protocol.

The sensor can be configured to be activated by a physical action, an audio action, and/or an optical action. The physical action can include shaking, breaking, pulling, pushing, or switching a physical sensor; or moving the personal safety device away from the mobile device, such that the personal safety device is out of communication range of the mobile telephone device (e.g., as determined by properties of the wireless link and/or the BT protocol), to activate a proximity sensor. The audio action can include making an active sound, such as an oral word, an oral shout or an impact sound, to activate an audio sensor. The optical action can include covering or exposing an optical sensor.

The device state can include: the activated state; a low-power state, corresponding to a device power supply having energy below a pre-selected energy threshold; and an out-of-proximity state, corresponding to the wireless link not being available, e.g., due to a sufficiently large separation between the personal safety device and the mobile device. The activated state can include a message-sent state corresponding to an alert signal having been sent by the mobile device. The activated state can include a call-back-received state corresponding to a call-back having been received from the recipient by the mobile device. The indicator can include an optical indicator, such as a light-emitting diode (LED), or a tactile indicator, such as a vibrator (e.g., provided by an off-set motor). The device power supply can include a battery, and the pre-selected energy threshold can be selected based on characteristics of the battery and represented by energy threshold data in the power module.

The indicator can include a display for displaying a display message to the user. The display message can represent the device state, a current time based on a clock, and/or a information associated with functions of the mobile device: e.g., a identifier of the originator of an incoming call or message to the mobile device, or content of an incoming text, multimedia or email message received by the mobile device, etc. The clock can be a PSD clock in the PSD (using a clock process in the memory, or a separate clock component) or a mobile clock in the mobile device, wherein time data is transmitted to the PSD by the wireless link.

The personal safety system can also include an alerting module of the mobile device configured to send an alert signal, based on the activation signal and alerting configuration data representing a recipient pre-selected by the user, to a recipient.

The alert signal can include message content including audio alert data, text alert data and/or pictorial alert data based on respective message content data, including audio message data, text message data and pictorial message data, accessed by the alerting module in the mobile device. The message content data can be selected by the user, or a default pre-determined by the personal safety system.

The alert signal can be generated based on contact data for the recipient. The alerting module can be configured to access or store the contact data, including: a name, a location (e.g., a street address, or a GPS location), a mobile telephone number, a fixed-line telephone number, a short-message number, a multimedia-message number, a facsimile number, an Internet server address, an instant messenger address, a program-specific address (e.g., for messaging on Skype, Facebook, etc.) and/or an email address. The contact data can be accessed in contacts data of the mobile telephone device. The at least one recipient can include a plurality of recipients, and the alerting module can be configured to store priority data, in association with the contact data for each recipient, representing a priority in which the plurality of recipients are sent their respective alert signal.

The alert content and a type of the alert signal can be selected and generated based on alerting rules data and the content data.

The alert signal can represent user location data, representing a location of user, generated based on location data of the mobile device. The location data can be generated by a location module of the mobile device by accessing satellite positioning data, such as global positioning system (GPS) data, or mobile positioning data, such as a cellular identifier (“cell ID”) of a cell of a mobile communications network. The cell ID can be provided by a Automatic Location Identification (ALI) module of the mobile device.

The alerting module can send a command signal to a mobile device controller (e.g., using an application program interface (API) of an operating system of the mobile device) to activate one or more functions of the mobile device in response to activation of the sensor. The activated functions of the mobile device can include audio-visual (AV) functions such as: audio functions (e.g., a mobile microphone and a mobile speaker), video functions (e.g., a mobile camera and a mobile display), recording functions (e.g., an audio recorder and a video recorder), and telephone functions (e.g., a communications connection with the recipient using audio and/or video).

The personal safety device can include an audio-visual (AV) input-output (IO) transceiver, such as a microphone and a speaker, for communicating audio signals between the user and the mobile device, and thus to and from the recipient.

The personal safety device can be disarmed to de-activate the alert signal using code data received by the mobile device, such as a personal identification number (PIN) entered into the mobile device using a user interface (e.g., a keypad) of the mobile device.

The sensor can include a user control for activating a secondary level alert in addition to the primary level alert based on a secondary activation by the user.

The personal safety system can include a personal safety server for receiving record data representing activation of the personal safety device, and for generating payment data representing a payment due for use of the system.

The mobile device can communicate with the recipient using a recipient link to a recipient device for playing and/or displaying a recipient message, based on the alert signal, to the recipient. The recipient link can include: a wireless telephone link (e.g., a Global System for Mobile communications (GSM) link, a General Packet Radio Service (GPRS) link, an Enhanced GPRS (EDGE) link, a Third Generation (3G) link, a Wideband Code Division Multiple Access (WCDMA) link, etc.); a telephone network (e.g., a telecommunications network, the public switched telephone network (PSTN), etc.); and/or a data network (e.g., the Internet, etc.).

In embodiments, the personal safety process can include the steps of: detecting an activation of a sensor by a user of a personal safety device; sending, in response to the activation of the sensor, an activation signal for generating an alert using a link to a mobile telephone device; indicating to the user a device state of the personal safety device, including an activated state corresponding to the activation of the sensor; and de-activating the alert using code data received by the mobile telephone device.

The personal safety system can include one or more computer-readable storage media having stored thereon program instructions for executing the steps of any one of the above processes.

### BRIEF DESCRIPTION OF THE DRAWINGS

Preferred embodiments of the present invention are hereinafter further described, by way of example only, with reference to the accompanying drawings, in which:

FIG. 1 is a schematic diagram of a personal safety system;

FIG. 2 is a block diagram of program modules of the personal safety system; and

FIG. 3 is a flow diagram of a personal safety process performed by the personal safety system.

### DETAILED DESCRIPTION OF THE INVENTION

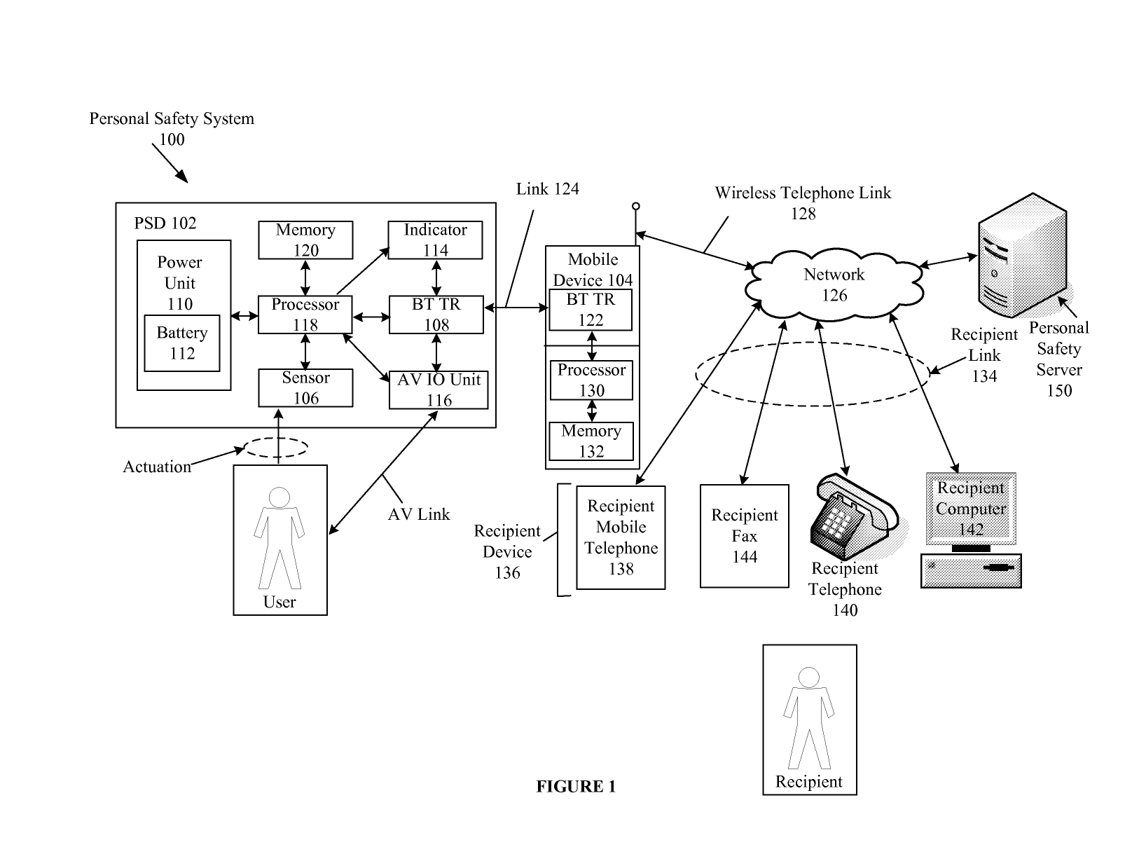

As shown in FIG. 1, a personal safety system 100 includes a personal safety device (PSD) 102, configured to connect a user of the PSD 102 to a recipient, preselected by the user, using an electronic communications path via a mobile device 104 (e.g., a mobile telephone) of the user.

The personal safety system 100 can alert designated people (referred to as the at least one “recipient”) of a situation of the user (e.g., their safety or need for help), quickly and without the user having to manually operate the user's mobile device 104. The user can activate the PSD 102 to send an alert signal. The alert signal can represent a predefined alert message (such as a text message, an email and/or a voice recording) for the recipient, and/or placement of a voice or video call to the recipient. A message or call can go to a plurality of recipients, e.g., as many as are selected by the user.

The user can use the PSD 102 in their home, i.e., at a pre-selected location, and a text message containing the user's home address can be a sufficient alert message for a prepared recipient.

The PSD 102 can activate audio-visual (AV) functions of the mobile device 104, e.g., a recording mode or camera mode of the mobile device 104, to capture audio-visual signals in response to the activation signal. Activation of the sensor causes the mobile device 104 to turn on its microphone and/or camera so that AV signals are captured for transmission to the recipient. The recipient can then listen to and/or see at least a portion of the environment of the user, which may be of assistance if the user is being attacked, etc, and the recipient (e.g., the police) wishes to identify the attacker.

The PSD 102 includes a protective casing, e.g., of hard plastic or metal, for protecting the components of the PSD 102, which is configured to be worn by the user. The PSD 102 is substantially waterproofed by the inclusion of plastic and/or rubber seals in the casing, to substantially resist water entering the PSD 102 when exposed to rain, splashed water, etc. The PSD 102 can be substantially sealed against any ingress of fluid at standard pressures and temperatures using a structure of a waterproof or water-resistant watch (e.g., splash resistant, or waterproof to a selected water depth).

As shown in FIG. 1, the PSD 102 includes a sensor 106, configured to receive input from the user, and a Bluetooth transceiver (BT TR) 108 configured to communicate with the mobile device 104. The sensor 106 is configured to be activated by the user to generate the alert signal. The sensor 106 is configured to be activated, or actuated, by a physical action (such as a manual action), an audio action (such as an oral action, e.g., a scream), an optical action (such as covering or exposing a light sensor), and/or a thermal action (such as changing the temperature of the PSD 102 by removing it from the user's body). The physical action can include shaking, breaking, pulling, pushing, or switching a physical sensor; or moving the PSD 102 away from the mobile device 104 to activate a proximity sensor. For example, the physical action can be: holding down a “help key” of the sensor 106 for more than a predetermined period of time (e.g., two seconds); or breaking a sensitive electronic or optical circuit of the PSD 102. The audio action can include making an active sound, such as an oral word (e.g., a specific word or words), an oral shout or an impact sound, to activate an audio sensor.

The sensor can include a user control, activated using one or more of the activation actions described above, that activates a secondary level alert, which can be simply making an outgoing call using the mobile device 104. For example, the secondary level alert (when a button is pressed) is less urgent, such as establishing a voice call with a preselected recipient. This is in contrast to the primary alert, which can be an emergency message sent to emergency contacts and/or emergency services including the police, paramedics and/or fire fighters. The user control can also be configured to control one or more pre-existing functions of the mobile device 104, such as answering an incoming telephone call or controlling a music player or camera, in a similar manner to a remote control of the mobile device 104.

The PSD 102 includes a power unit 110, for providing power to the other components of the PSD 102, and the power unit 110 includes a battery 112 for storing electrical energy. The power unit 110 generates a stored-energy signal, which is used to detect when stored energy in the battery 112 is low, and that the battery may need replacing.

The PSD 102 includes an indicator 114 for indicating to the user that the PSD 102 is in a particular device state, such as being turned on (i.e., being in an “on state”), or having low stored energy in the battery 112 (i.e., being in a “low-power state”), or having received an input via the sensor 106 (i.e., being in an “activated state”), or being out of BT communication range with the mobile device 104 (i.e., being in an “out-of-proximity” state), etc. The indicator 114 includes a display, such as a liquid crystal display, for displaying time and message information (including messages associated with functions of the mobile device 104, e.g., an originator identifier (ID). The originator ID identifies an origin of a call or message received by the mobile telephone device 104 The originator ID can be the caller ID—also referred to as the calling line identification (CLID)—of an incoming telephone call, i.e., the telephone number of the party making an incoming telephone call to the mobile telephone device 104. The originator ID can also be an identifying number (e.g., a telephone number) or code (e.g., an email address, or Twitter handle) of an incoming message.

The PSD 102 includes an audio-visual input-output (AV 10) unit 116 for receiving audio-visual information from the user, such as speech, and sending audio-visual information to the user, such as speech from the recipient.

The sensor 106, the power unit 110, the indicator 114, the AV IO unit 116 and the BT TR 108 are monitored and controlled by a processor 118 of the PSD 102 which accesses computer-readable storage or memory 120 of the PSD 102 to access instructions to perform the various processes of the personal safety system 100.

As shown in FIG. 1, the mobile device 104 includes a short range wireless transceiver in the form of a Bluetooth transceiver (BT TR) 122 configured to communicate electronically with the PSD Bluetooth transceiver 108 using a Bluetooth wireless link 124. The mobile device 104 communicates electronically with a network 126 using a wireless telephone link 128 and an antenna of the mobile device 104. The mobile device 104 includes a mobile processor 130 and a mobile computer-readable memory 132 for controlling the mobile device 104 and storing instructions for performing the processes of the personal safety system 100.

As shown in FIG. 1, the recipient is in communication with the user using the PSD 102, the mobile device 104, and a recipient link 134 between the mobile device 104 and a recipient device 136. The recipient device 136 can include at least one of a recipient mobile telephone 138 (including a wireless device such as a VOIP phone or an iPhone or a Blackberry), a recipient landline telephone 140 (including a telephone call centre), a recipient computer 142, and/or a recipient facsimile (fax) machine 144. The nature of the recipient link 134 is associated with the nature of the recipient device 136: for example the recipient link 134 may be a fixed line telephone link, an Internet link, or a wireless telephone link, etc., as defined by the nature of the recipient device 136.

As shown in FIG. 1, the personal safety system 100 includes a personal safety server 150 in communication with the network 126, and in particular the Internet, for receiving usage data relating to usage of the personal safety system 100. The personal safety server 150 can receive the usage data from the mobile device 104, from the recipient device 136 and/or from other components of the network 126 such as a mobile telecommunications provider that provides access for the mobile device 104 to the network 126. The personal safety server 150 maintains data representing a personal account for a user and records usage data representing use of the personal safety system 100 including the sending of the alerting signals. The personal safety server 150 may periodically generate payment data representing invoices for the user to pay for use of the personal safety system 100. In an example, the personal safety server 150 can receive data indicating that the mobile device 104 has dialed a premium telephone number (e.g., a 1-900 number), and the user can be identifier (e.g., using a telephone number associated with the mobile device 104) and invoiced for use of the premium service.

The PSD 102 is configured to be worn by the user, for example as a discrete piece of jewelry (e.g., with a necklace, a ring, a watch, a brooch, a pendant, earrings, a bracelet, etc.), as part of an item of clothing (e.g., with a button, a hat, a belt buckle, a shoe, etc.) or as a device commonly carried on the person (e.g., a pen or wallet card, etc.). The size and weight of the PSD 102 is related to its casing which may be metal or plastic, and whether certain units—such as the indicator 114, the battery 112 and the audio visual input/output unit 116—are included or excluded from the particular embodiment of the PSD 102. For example, a smaller, more discrete PSD 102 can have a smaller battery 112.

The indicator 114 includes a small vibrating motor (e.g., an off-set motor) and/or a light (e.g., a light-emitting diode or LED) which indicates the state of the PSD 102. The motor is a form of tactile indicator, which provides a tactile indication that is perceptible to the user's sense of touch. When the sensor 106 has been activated and the mobile device has initiated the alert message(s) to the recipient(s) (the activated state); when the PSD 102 and the mobile device 104 are no longer connected by the wireless link 124 (the out-of-proximity state); and when the battery power is getting low (the low-power state). The indicator 114 can include the display for displaying time and message information, such as the current time, a caller identification (ID) of an incoming call to the mobile device 104, and an incoming text or multimedia message received by the mobile device 104. The clock is an electronic clock provided by a clock process in the PSD 102, and run in the PSD processor 118. Alternatively, the clock can be a mobile clock in the mobile device 104, and the time data can be transmitted to the display of the indicator 114 using the wireless link 124. Data for the display of an incoming caller ID, or display of content of an incoming text message or multimedia message, is also transmitted from the mobile device 104 over the wireless link 124 to the display of the indicator 114. The display can also display information relating to the device state, such as the low-power state, the out-of-proximity and the activated state, etc.

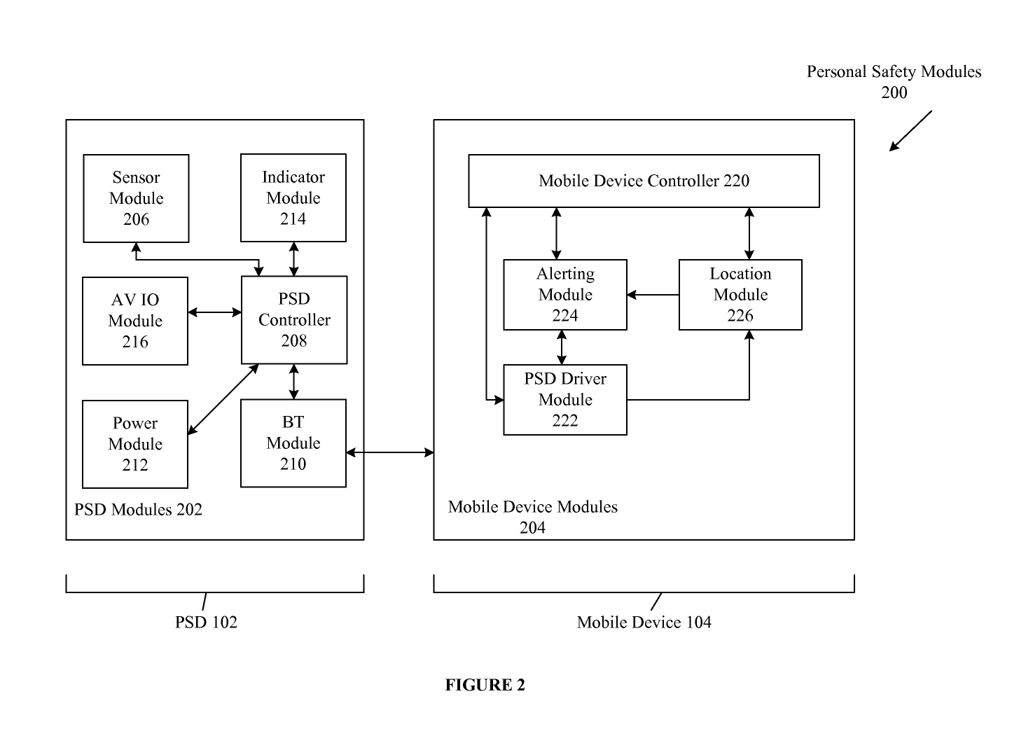

As shown in FIG. 2, the personal safety system 100 includes a plurality of personal safety modules 200 in the form of software program modules stored in the PSD memory 120 and the mobile memory 132 for performing the processes of the personal safety system 100. The PSD 102 includes PSD modules 202 for controlling the PSD 102, and the mobile device 104 includes mobile device modules 204 for controlling the mobile device 104. In embodiments, further software program modules are included in the personal safety server 150, e.g., for establishing the recipient link 134 and recording usage data.

As shown in FIG. 2, the PSD modules 202 include a sensor module 206 for detecting activation of the sensor 106 and communicating with a PSD controller module 208, which controls and coordinates data transfer between the various PSD modules 202. The PSD modules 202 include a Bluetooth (BT) module 210 for sending and receiving data between the PSD controller module 208—e.g., relating to activation of the sensor 106—and the mobile device 104 using the BT transceiver 108. The PSD modules 202 include a power module 212 for monitoring the power unit 110, and an indicator module 214 for controlling the indicator 114. The PSD modules 202 also include an audio-visual input-output (AV IO) module 216 for monitoring and controlling the AV IO unit 116. The PSD controller module 208 is in communication with the other PSD modules 202 via corresponding electronic data communication links. The PSD modules 202 include a clock module, which can be part of the indicator module 214 on the PSD controller module 208, for generating current time data.

As shown in FIG. 2, the mobile device modules 204 include a mobile device controller module 220, which controls the majority of the functions of the mobile device 104. The mobile device controller module 220 includes the operating system of the mobile device 104, such as the Symbian operating system, and a user interface platform such as the “Series 60” (or S60) software platform and corresponding application program interface (API) for the mobile device 104.

As shown in FIG. 2, the mobile device modules 204 include a PSD driver module 222 for controlling the mobile device 104 to perform the processes of the personal safety system 100. The PSD driver module 222 can include computing commands for controlling the mobile device controller module 220 such as developed in Java for the S60 platform. The PSD driver module 222 receives signals from the PSD 102 using the mobile Bluetooth transceiver 122 of the mobile device 104, which is monitored and controlled by the mobile device controller module 220. The mobile device modules 204 include an alerting module 224 for accessing alerting data relating to alerts activated by the user, including contact information data for the at least one recipient, message content data for the alert message(s), location data about the location of the user, and alerting rules data to determine which alert(s) to send to which recipient(s) in what priority order. The alerting module 224 is controlled by the PSD driver module 222 and is in communication with the mobile device controller module 220 for sending alerts (also referred to as “alert signals”). Alerting configuration data is stored in the memory 132 of the mobile device 104 and is accessed by the alerting module 224. The alerting configuration data represents portions of the alerting data that are not dynamic, e.g., the contact data, pre-selected message content data, pre-selected location data and the pre-defined alerting rules data. The mobile device modules 204 include a location module 226 for generating dynamic location data of the mobile device 104 from the mobile device controller module 220, e.g., using satellite positioning data (for a mobile device 104 with satellite positioning, or having an associated satellite positioning module generating and transmitting positioning data to the mobile device 104), and/or cellular positioning data (for a mobile device 104 with Automatic Location Identification), associated with the mobile telephony cell of the mobile device 104 and the wireless telephone link 128. The location module 226 dynamically determines location data of the mobile device 104 and provides this data to the alerting module 224 for generating alerts. In some embodiments, the alert signal includes the dynamic location data (e.g., a GPS location); in other embodiments, the alert signal includes static location data (e.g., a predefined street address of the user). Current time data is received by the PSD driver module 222 from an internal clock module of the mobile device controller module 220 using the mobile device API.

In at least some embodiments, the dynamic location data can be converted into street address data, representing a street address associated with the location of the user, based on conversion data (such as mapping data etc.) in the alerting module 224, in the mobile device controller 220 (such as built-in maps of the mobile device 104) and/or by mapping data available via the network 126 from a mapping server (such as the Google Maps server). The street address data may be in the form of a house number, street address and suburb, or simply in the form of an approximate street address, e.g., based on the mobile cell ID data. Having the dynamic location data formatted as a street address can assist the recipient in locating the user if the recipient does not have access to a map with latitude and longitude information. For example, the street address data may provide the recipient with a street address or suburb in an SMS on their mobile telephone that can be used to access a street directory, including a printed hardcopy street directory.

The PSD 102 and the mobile device 104 include the configuration data stored in the PSD memory 120 and the mobile memory 132, respectively. The configuration data in the mobile device 104 include the alerting configuration data which determines the content and form of the alerting signals sent by the personal safety system 100. The alerting configuration data is entered into the mobile device 104 either as default data when the components of the personal safety system 100 are installed on the mobile device 104, e.g., as program components, or entered by the user (or another person such as a vendor) into the mobile device 104 using the user interface of the mobile device 104 or an alternative configuration system (e.g., the mobile device 104 may be placed in electronic communication with a configuration device, such as a computer, which allows the configuration data to be downloaded to the mobile device 104, including over a wired connection or a wireless connection, which may include the network 126 with at least a portion of the configuration data being downloaded from the personal safety server 150).

The alerting configuration data determines, for each user and each alert signal, the types of alerts to be sent, including whether the alert is associated with the primary level alert, or the secondary level alert (typically a less urgent alert). For example, the alerting configuration data can determine that the alert signal is a “make call” signal to establish a telephone call, and the call can be selected to be a normal voice phone call, a video phone call, a call using the AV IO unit 116 of the PSD 102, or simply an audio message sent to the recipient based on pre-recorded audio data in the alerting configuration data. The alerting configuration data can be reconfigured by the user at any point, e.g., by entering a code such as a personal identification number, and making configuration selections using the user interface of the mobile device 104. The alerting configuration data can determine how the out-of-proximity alert is generated, e.g., by sending an alert signal to the recipient, or by simply activating the indicator 114 on the PSD 102. The alerting configuration data can be selected to represent a plurality of recipients to be contacted by a plurality of respective messages, in a selected order of priority. The priority of each message is defined in priority data associated with the contact data of each recipient: for example, the priority data may represent that a first recipient, such as an ambulance service, is to receive a pre-recorded voice message describing the location and name of the user, as a first priority, and a family member is to receive an SMS with the dynamic location of the user as a second priority.

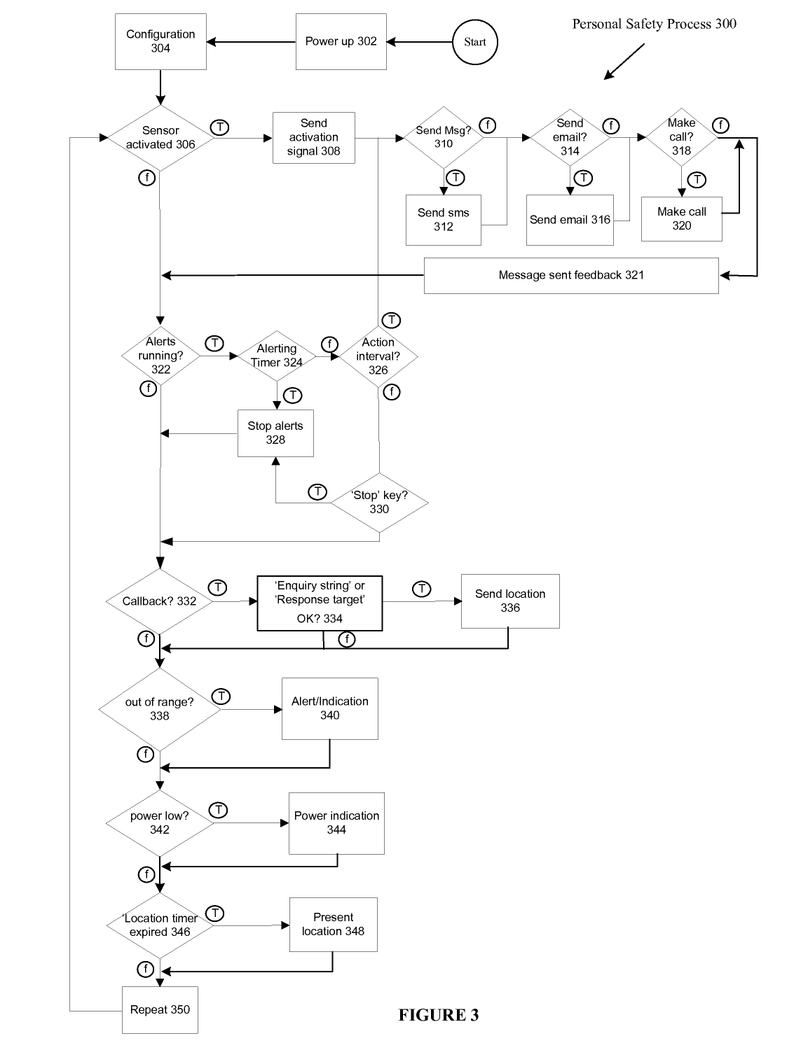

As shown in FIG. 3, in a personal safety process 300 performed by the personal safety system 100, the mobile device 104 and the PSD 102 are turned on (or “powered up”) and the PSD 102 establishes the wireless link 124 between the PSD 102 and the mobile device 104, using a Bluetooth “pairing” process (step 302). In the power-up step 302, the personal safety modules 200 are activated and commence operation. Following the power-up step 302, the PSD 102 and the mobile device 104 perform the following configuration processes (step 304): the PSD BT module 210 stores the Bluetooth parameters of the mobile device 104, e.g., a device name and any Bluetooth code, for establishing and maintaining the wireless link 124; the module 206 prepares the sensor 106 for potential activation by the user; the indicator module 214 activates the indicator 114 to indicate that the PSD 102 is turned on; the alerting module 224 accesses alerting data associated with an identifier of the PSD 102 received from the PSD BT module 210, e.g., a Bluetooth ID of the PSD 102, and accesses the corresponding alerting configuration data in the mobile memory 132 (or in some embodiments from the server 150 via the network 126) for generating the alert signal when required; the location module 226 accesses the dynamic location data and sends it to the alerting module 224 for sending with the alert signal (e.g., a GPS location from the mobile device controller module 220); and the mobile device controller module 220 establishes the wireless telephone link 128 with the network 126 as in standard mobile telecommunications, e.g., by locating and contacting the nearest wireless cell tower.

Once the personal safety system 100 is powered up and configured (in steps 302 and 304), the PSD 102 remains in an active state waiting for an activation by the user. In the active state, the sensor module 206 firstly monitors the sensor 106 for any activation (step 306). If the sensor 106 is activated, as tested in step 306, the sensor module 206 sends an activation signal to the PSD controller module 208 which sends the activation signal to the mobile device 104 using the BT module 210 and the wireless link 124 (step 308). The PSD driver module 222 receives the activation signal and determines an alert signal to be sent to the recipient based on the alerting rules, including whether to send an SMS or MMS (step 310), whether to send an email (step 314) and whether to establish a telephone or video phone link (step 318). The type of the alert signal is also determined based on the contact data for the recipient, accessed by the alerting module 224, for example whether the selected recipient has a mobile telephone number or an email address in their contact data. Depending on the determination of whether an alert signal is sent, and the type and content of the alert signal, the alert signal is transmitted via the wireless telephone link 128 as an SMS or MMS message (step 312), an email (step 316), or a telephone call (step 320) etc. Once the alert signal has been sent, the PSD driver module 222 receives confirmation of the alert signal having been sent from the alerting module 224, and sends a signal to the PSD controller module 208 confirming sending of the alert signal, thus moving the PSD 102 into the message-sent state. The PSD controller module 208 controls the indicator module 214 to activate the indicator 114 to indicate to the user that the alert signal has been sent, thereby providing message-sent feedback, such as a beep, flash or vibration, or a feedback message such as “Alert Running” on the display (step 321). This feedback message to the user confirms to the user that the personal safety system 100 is operating.

As shown in FIG. 3, if the sensor 106 is not activated when tested in step 306, the PSD driver module 222 then determines whether any alerting signal is currently running, e.g., due to the sensor 106 having been activated and not disarmed, and that the alerting module 224 is sending the alert signal or maintaining a telephone call, and that any consequent alert communications, e.g., activation of two-way communications between the user and the recipient via the AV IO unit 116, and/or the mobile device 104, are currently active (step 322). If any actions are running, determined in step 322, the PSD driver module 222 determines whether an alerting timer has expired (step 324). The alerting timer limits the duration of sending the alert signal, e.g., to 1 hour or 1 day, as preset (preselected) in the alerting configuration data. If the alerting timer has not expired, the PSD driver module 222 determines whether an action interval time has expired (step 326). The action interval time determines how long the personal safety system 100 waits between repeat sending of the alert signal, e.g., how long to wait before resending a message or re-establishing a telephone call, during the duration defined by the alerting timer. The action interval can be 1 second, or 5 seconds, or 30 seconds, or 1 minute, or 1 hour, as preset (preselected) in the alerting configuration data. If the action interval time has expired, as determined in step 326, the PSD driver module 222 activates an additional or repeat alert signal, as described above with reference to steps 310, 314 and 318.

If the alerting timer has expired, as determined in step 324, the PSD driver module 222 stops generation of the alert signal, in the alerting module 224, and stops any communications link between the user and the recipient (e.g., a voice or video call provided by the AV 10 unit 116 and/or the microphone, speaker, camera and display of the mobile device 104) (step 328). If the alerting actions are running, as determined in step 322, following step 326, the PSD driver module 222 determines whether a disarm request to cancel the alert has been received, e.g., due to a “stop” key (or “disarm key”) being entered on the user interface of the mobile device 104 (step 330). The generation of the alert signal by the alerting module 224 is deactivated (or “disarmed”) by the user operating the user interface of the mobile device 104 and sending a deactivation code to the PSD driver module 222 via the mobile device controller to deactivate the alerting module 224. The deactivation code may be a personal identification number (PIN) code for the mobile device 104. If the stop key has been entered, as determined in step 330, the alerting actions are stopped, in step 328, as described above.

Once any actions have been stopped, in step 328, or the action interval has not expired (as determined in step 326), and the “stop” key has not been entered (as determined in step 330), the PSD driver module 222 determines whether any call-back has been received from the recipient, e.g., by SMS, email, MMS, voice call, video call etc. (step 332). A call-back indicates that a signal has been returned from the recipient in response to the alert signal. Reception of the call-back signal puts the personal safety system 100 into a call-back-received state. The driver module 222 responds to the call-back signal by sending a call-back-received signal to the PSD controller module 208, moving the PSD 102 into the call-back-received state. The PSD controller module 208 activates the indicator 114, using the indicator module 214, to indicate that the call-back has been received (e.g., the indicator 114 can beep, or flash, or display a message). If a call-back has been received, as determined in step 332, and if the call-back includes a request for updates of the location information (referred to as an “Enquiry String”), and the mobile device 104 is configured (by the alert configuration data) to send dynamic updates of location data (step 334), the PSD driver module 222 commands the alerting module 224 to send location data to the recipient device 136, based on the dynamic location data from the location module 226, including latitude, longitude, universal common time, and the mobile cell identifier (ID) of the wireless telephone link 128 to the mobile device 104, and/or based on static location data (such as the user's address) predefined in the alerting configuration data. Steps 334 and 336 allow the mobile device 104 to continuously and repeatedly send the location of the mobile device 104 to the recipient(s), which allows the recipient to receive the updated location data, which may change if the mobile device 104 is being moved during the alerting process, e.g., if the person moves after activating the alert signal. The dynamically updated location data can be used by the recipient to track the user, for example if the recipient is travelling to the location defined in the location data by, for example, tracking it on an in-vehicle GPS and mapping unit.

As shown in FIG. 3, the PSD driver module 222 determines whether the PSD 102 is out of range of the wireless link 124 from the mobile device 104, where an out-of-range condition (also referred to as an “out-of-proximity condition”) is defined by a signal from the mobile device controller module 220 that the PSD 102 is no longer in wireless contact with a mobile device 104 via the wireless link 124, e.g., based on the Bluetooth protocol (step 338). The out-of-range condition is determined by the PSD driver module 222 commanding the mobile device 104 to send a test, or polling, message (represented by polling data) to the PSD 102; in response to the polling message, the PSD 102 generates an acknowledgement message (represented by acknowledgement data), which when received by the mobile device 104, allows the PSD driver module 222 to determine that the mobile device 104 is still within range. If the PSD 102 is out of range, as determined in step 338, the PSD driver module 222 commands the alerting module 224 to activate the alert signal in the same manner as the alert signal is activated when the sensor 106 is activated. In alternative embodiments, the out-of-range alert signal has different characteristics to the alert signal generated due to activation of the sensor 106, for example the out-of-range alert signal may be directed to a different recipient. Additionally, in steps 338 and 340, the PSD controller module 208 determines that the PSD 102 is out of range because no data is being received from the mobile device 104, or because the BT connection strength falls below a selected signal strength (thus indicating the wireless link 124 is no longer established or operational), and the PSD controller module 208 controls the indicator module 214 to activate the indicator 114 and indicate to the user that the PSD 102 is out of range (in step 340). The user may then move the PSD 102 back into range of the mobile device 104 and thus re-establish the wireless link 124, at which point the PSD controller module 208 receives confirmation from the Bluetooth module 210 that the wireless link 124 is re-established, and then controls the indicator module 214 to cease operation of the indicator 114. In some embodiments, the PSD driver module 222 de-activates the out-of-range alert signal when the wireless link 124 is re-established; in other embodiments, it is necessary for the disarm request to be received before the out-of-range alert is de-activated. The out-of-range indication can remind the user to carry their mobile device 104 if they move too far away from it, e.g., by walking away from their home, office or car, and leaving the mobile device 104 inside.

As shown in FIG. 3, the PSD controller module 208 receives data from the power module 212 to determine whether the power (or the energy) from the power unit 110 is less than a preselected threshold, e.g., determined based on characteristics of the battery 112 and the power usage level of the PSD 102, e.g., such that less than 4 hours, or 1 hour, of operation is remaining (step 342). If the PSD controller module 208 determines in step 342 that the power is low, the PSD controller module 208 controls the indicator module 214 to indicate to the user that the power is low, e.g., by flashing the LED or vibrating the PSD 102 in a characteristic pattern (step 344). The PSD controller module 208 can also indicate to the PSD driver module 222 that the power is low, which can activate a low-power alert, e.g., a secondary alert rather than an emergency alert.

As shown in FIG. 3, the PSD driver module 222 of the mobile device 104 determines whether a location timer has expired, the location timer being selected to define a location timing frequency, such as once every hour, or minute, or second (step 346). The location timer is defined in the alert configuration data. If the location timer has expired, as determined in step 346, the PSD driver module 222 controls the location module 226 to receive data from the mobile device controller 220 relating to the present location, which can involve activating or “waking” a GPS unit associated with the mobile device 104, or poling the mobile cell identifier (step 348).

In some embodiments, the PSD driver module 222 controls the GPS unit associated with the mobile device 104 to be continuously operating at preselected times, e.g., at preselected times of the day and/or week. In some mobile devices, the GPS unit can take some minutes (e.g., 5 minutes) to locate a satellite signal after being activated (or “awoken”) and generate data representing the present location, thus it would be desirable to have the GPS unit active at all times to avoid a delay when sending location data in an emergency; however, having the GPS unit operational at all times can be draining on the battery of the mobile device 104. Therefore, the PSD driver module 222 can be configured to keep the GPS unit activated (or “awake”) during high-risk, or important, times. For example, important times for a school child may be during the times of travel between school and home in the morning and in the afternoon on school days; for a young adult, the important times may be during the evenings on weekends when the user is likely to be away from home and/or potentially with strangers. To provide these continuous activation times for the GPS unit, the PSD driver module 222 determines whether the GPS module should be in continuous operation based on data (in the configuration data) representing scheduled times for each user, in step 346. If the GPS unit is to remain active, the GPS unit does not need to be activated in step 348, but is kept active. The schedule of GPS times can be selected by the user using the user interface of the mobile device 104; for example by entering times and dates in a calendar.

The personal safety process 300 is repeated in a loop by the PSD driver module 222 and the PSD controller module 208 returning to the determination of sensor activation in step 306. The personal safety process 300 continues to iterate through the above-described steps until the PSD 102 or the mobile device 104 is powered off (step 350).

In an example embodiment, the alerting module 224 can include at least a portion of the “Smart SOS” application for the mobile device 104, from Enpronomic Solutions corporation of Cairo, Egypt (see http://www.enpronomics.com). The location module 226 can include at least a portion of the “GPS Tracker” application which provides a mobile application for collecting internal or external GPS information from a GPS module either internal or external to the mobile device 104. The GPS Tracker application generates the dynamic location data as a text file or as a GPX file (i.e., using the GPX mark-up language format). The GPS Tracker application can provide longitude and latitude information together with altitude information, speed information, direction (compass) information, and accuracy information of the location data. The location module 226 generates the location data suitable for an online mapping application served from the network 126 to the recipient, such as an Internet-based computing device of the recipient, for displaying the location data on a map, such as the “Google Latitude” online application from Google Inc. of Mountain View, Calif., USA. The PSD 102 can include one or more components of a Bluetooth device such as a Bluetooth headset, or a Bluetooth game controller (e.g., the BGP 100 “GamePad”). The mobile device 104 can be a smart phone from a manufacturer such as Nokia Corporation, Samsung, LG, Panasonic, Sony Ericsson, Apple Inc., or Palm.

In embodiments, the mobile device 104 includes a standard mobile computer system such as an Symbian operating system, or a Windows Mobile operating system, and the personal safety modules 200 are installed thereon, being compiled from code written in a development language such Java or C++, etc., and using a software development kit (SDK) associated with the operating system. The operating system of the mobile device 104 is configured to accept embedded software to perform the functions of the mobile device module 204. The boundaries between the personal safety modules 200 are exemplary and alternative embodiments can merge modules or impose an alternative decomposition of functionality of modules. For example, the modules discussed herein can be decomposed into submodules to be executed as multiple computer processes, and on multiple processors. Moreover, alternative embodiments can combine multiple instances of a particular module or submodule. Furthermore, the operations can be combined or the functionality of the operations can be distributed in additional operations: for example, at least part of the processes performed by the PSD driver module 222 can be performed by the PSD modules 202, or a server of the network 126 configured to perform part of the processing of the personal safety process 300. Alternatively, the processes can be embodied in the structure of circuitry that represents the modules, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like. Each of the blocks of the flow diagram of the personal safety process 300, and other steps of processes performed by the personal safety system 100, are executed by the modules of the personal safety modules 200, or a portion of a module. The processes can be embodied in a machine-readable and/or computer-readable medium, such as the memories 120, 132, for configuring the processors 118, 130 to execute the processes. The digital code of the personal safety modules 200 can be stored within and/or transmitted to the memory components 120, 132 to configure the respective PSD 102 and mobile device 104 to perform the functions of the respective PSD module 202 and mobile device modules 204. The processors 118, 130 of the PSD 102 and the mobile device 104 normally processes information according to a program, which is a list of internally stored instructions such as a particular application program and/or an operating system, and produce resultant output information via I/O components. In the operating processors 118, 130, parent processes can spawn other, child processes to help perform the overall functionality of the parent processes, and because the parent processes specifically spawn the child processes to perform a portion of the overall functionality of the parent processes, the functions performed by child processes (and grandchild processes, etc.) can be described as being performed by the parent processes.

In some embodiments, the alert signal sent by the PSD driver module 222 in one of steps 312, 316 and 320 can be to a premium contact service, such as a premium telephone service (e.g., a 1-900 number provided by a telecommunications carrier). The alert signal is then directed by the network 126 in accordance with its configuration (e.g., for the 1-900 number) to the personal safety server 150. Thereafter, an alerting module in the personal safety server 150, which provides functionality generally equivalent to the alerting module 224 of the mobile device modules 204, receives the alert signal, and identification details of the mobile device 104 (e.g., an originating telephone number) and determines therefrom the identity of the user (e.g., based on a user account of the user in the personal safety server 150). The personal safety server 150 includes modules configured to send an alert signal based on the activation signal—equivalent to the alert signal sent by the mobile telephone device 104—to the recipient device 136 of the recipient. The alerting module in the personal safety server 150 then performs the steps of the personal safety process equivalent to the steps provided by the alerting module 224. In this way, the mobile device 104 need only transmit a short alert signal, including identifying details of the mobile device 104 and/or of the PSD 102, and the personal safety server 150 can identify that the user has activated an alert, and then proceeds to generate alert signals for the one or more recipients. The alerting module of the personal safety server 150 can also receive location data from the mobile device 104, e.g., as determined by the location module 226, which can send the location data over the wireless telephone link 128. The modules of the personal safety server 150 can generate invoice data for the user's use of the personal safety system 100 in accordance with billing procedures of the telecommunications network that provides the wireless telephone link 128 (e.g., by charging services to the user's telephone bill, as with typical 1-900 premium services). The personal safety server 150 contains the alerting configuration data, and this can be updated by the user using a connection to the network 126, such as an Internet connection, or by contacting a call centre with operators who can update the alerting configuration data for each user.

The personal safety system 100 is used by the user when they wish to contact the recipient, e.g., in a time of emergency. For example, if the user feels that their life is being threatened or they are in danger, they activate the sensor 106 by, for example, pulling on a pull cord associated with the sensor 106 or attached to a necklace, or by pushing or turning one button (or a combination of buttons) on a wrist watch. The sensor 106 can include a conductive loop in a necklace or bracelet, and the sensor 106 is activated when the conductive loop is broken by breaking the necklace or the bracelet. The mobile device 104, such as the user's mobile telephone, must be switched on, in which case it automatically dials the selected recipient(s) from a list of emergency contacts in the contacts data of the alerting module 224.

Example users of the personal safety system 100 can include children with their parent's details represented by the contact data, elderly people or infirm people with an assistant's details represented in the recipient contact data (e.g., a nurse, helper, doctor, ambulance, friend or relative), security or enforcement personnel who are likely to come into danger (e.g., police, bouncers, security guards, shop employees, etc.), people going into any dangerous situation such as at night in a big city or travelling in an isolated area with network coverage, on holidays in a foreign destination, where the mobile device 104 is configured to operate in a foreign part of the network 126, drivers, or cyclists, etc. For example, if a group of friends are travelling together late at night in a city to visit bars, pubs and nightclubs, members of the group can select other members of the same group to be included as recipients, so that on activation of any one user's PSD 102, the other members of the group are alerted by the alert signal.

The alerting module 224 may, through control of the mobile device controller module 220, switch the mobile device 104 into a transmitting and receiving mode, as with a normal telephone conversation, allowing the user and the recipient to communicate with each other verbally, to hear each other, and optionally to see each other using the camera and the screen of the mobile device 104. This may be particularly useful, for example, if the user is injured or in medical danger, and the recipient is a skilled healthcare worker such as a paramedic able to assist the user through the mobile device 104. Having the mobile device 104 in communication mode may also allow for the recipient, such as police or an emergency call centre (e.g., a 000, or 911 service) to monitor the situation of the user, for example if the user is in a dangerous situation for other people to enter, or if the user is being attacked and the attacker must be identified.

In some embodiments, the PSD 102, including the AV IO unit 116, can provide the functionality of a Bluetooth headset by providing the microphone and speaker functions of the mobile device 104 at the PSD 102. For example, the PSD 102 includes a microphone that communicates audio signals to the mobile device 104 via the AV IO unit 116 in the PSD 102 and the wireless link 124.

Many modifications will be apparent to those skilled in the art without departing from the scope of the present invention as hereinbefore described with reference to the accompanying drawings.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### REFERENCE SIGNS

| Reference | Item |
|---|---|
| 100 | personal safety system |
| 102 | personal safety device |
| | (PSD) |
| 104 | mobile device |
| 106 | sensor |
| 108 | PSD Bluetooth transceiver |
| | (BT TR) |
| 110 | power unit |
| 112 | battery |
| 114 | indicator |
| 116 | audio visual input/output |
| | (AV IO) unit |
| 118 | PSD processor |
| 120 | PSD memory |
| 122 | mobile Bluetooth |
| | transceiver (BT TR) |
| 124 | Bluetooth wireless link |
| 126 | network |
| 128 | wireless telephone link |
| 130 | mobile processor |
| 132 | mobile computer-readable |
| | memory |
| 134 | recipient link |
| 136 | recipient device |
| 138 | recipient mobile telephone |
| 140 | recipient landline telephone |
| 142 | recipient computer |
| 144 | recipient fax machine |
| 150 | personal safety server |
| 200 | personal safety modules |
| 202 | PSD modules |
| 204 | mobile device modules |
| 206 | sensor module |
| 208 | PSD controller module |
| 210 | PSD Bluetooth (BT) |
| | module |
| 212 | power module |
| 214 | indicator module |
| 220 | mobile device controller |
| | module |
| 222 | PSD driver module |
| 224 | alerting module |
| 226 | location module |
| 300 | personal safety process |

What is claimed as new and desired to be protected by Letters Patent of the United States is:

1. A personal safety system, including:
a mobile telephone device; and
a personal safety device, including:
a sensor,
a transceiver module configured to send, in response to activation of the sensor by a user, an activation signal to the mobile telephone device via a wireless link, and
an indicator configured to indicate to the user: a device state of the personal safety device, including an activated state corresponding to the activation of the sensor; and reception of an incoming call or message by the mobile telephone device,
wherein:
the mobile telephone device is configured to generate an alert signal based on the activation signal, and to send the alert signal to a recipient based on alerting configuration data representing the recipient pre-selected by the user;
the alert signal represents user location data representing a location of the mobile telephone device; and
the sensor includes a proximity sensor which is activated by the personal safety device being out of communication range of the mobile telephone device.

2. The personal safety system of claim 1, wherein the mobile telephone device is configured to de-activate the alert signal using a stop code received by the mobile telephone device.

3. The personal safety system of claim 1, wherein the indicator includes a tactile indicator.

4. The personal safety system of claim 1, wherein the personal safety device includes a microphone configured to communicate audio signals from the user to the mobile device for the recipient.

5. The personal safety system of claim 1, wherein the indicator includes a display configured to display a display message to the user, wherein the display message represents the device state of the personal safety device.

6. The personal safety system of claim 5, wherein the display message represents information associated with a function of the mobile telephone device.

7. The personal safety system of claim 6, wherein the display message represents an originator identifier that identifies an origin of a call or message received by the mobile telephone device.

8. The personal safety system of claim 1, wherein the mobile telephone device is configured to activate one or more audio-visual functions of the mobile telephone device to capture audio-visual signals in response to receiving the activation signal.

9. The personal safety system of claim 1, wherein the personal safety device includes a user control configured to control one or more functions of the mobile telephone device.

10. The personal safety system of claim 9, wherein the one or more functions include answering an incoming call to the mobile telephone device.

11. The personal safety system of claim 1, including a personal safety server configured to receive data representing the activation of the personal safety device from the mobile telephone device over a communications network.

12. A personal safety process including:
detecting an activation of a sensor of a personal safety device by a user;
sending, in response to detecting the activation, an activation signal to a mobile telephone device via a wireless link;
indicating to the user a device state of the personal safety device, including an activated state corresponding to the activation of the sensor;
indicating, by the personal safety device, to the user reception of an incoming call or message by the mobile telephone;
generating an alert signal based on the activation signal by the mobile telephone device; and
sending the alert signal by the mobile telephone device to a recipient, based on alerting configuration data representing the recipient pre-selected by the user,
wherein:
the alert signal represents user location data representing a location of the mobile telephone device; and
the sensor includes a proximity sensor which is activated by the personal safety device being out of communication range of the mobile telephone device.

13. The personal safety process of claim 12, including de-activating the alert signal using a stop code received by the mobile telephone device.

14. The personal safety process of claim 12, wherein the indicating includes tactile indicating.

15. The personal safety process of claim 12, including communicating audio signals from the user to the recipient using the personal safety device and the mobile device.

16. The personal safety process of claim 12, including activating one or more audio-visual functions of the mobile telephone device to capture audio-visual signals in response to receiving the activation signal.

17. The personal safety process of claim 12, including sending data representing the activation of the personal safety device from the mobile telephone device to a server over a communications network.

18. Computer-readable storage having stored thereon programming instructions configured to cause one or more processors to execute the process of claim 12.

19. A personal safety system, including:
a mobile telephone device; and
a personal safety device, including: a sensor, and a transceiver module configured to send, in response to activation of the sensor by a user, an activation signal to the mobile telephone device via a wireless link,
wherein:
the mobile telephone device is configured to generate an alert signal based on the activation signal, and to send the alert signal to a recipient based on alerting configuration data representing the recipient pre-selected by the user;
the alert signal represents user location data representing a location of the mobile telephone device; and
the sensor includes a proximity sensor which is activated by the personal safety device being out of communication range of the wireless link.

20. A personal safety process including:
detecting an activation of a sensor of a personal safety device by a user;
sending, in response to detecting the activation, an activation signal to a mobile telephone device via a wireless link;
generating an alert signal based on the activation signal by the mobile telephone device; and
sending the alert signal by the mobile telephone device to a recipient, based on alerting configuration data representing the recipient pre-selected by the user,
wherein:
the alert signal represents user location data representing a location of the mobile telephone device; and
the sensor includes a proximity sensor which is activated by the personal safety device being out of communication range of the wireless link.
